(19) United States
(12) Patent Application Publication
(10) Pub. No.: US 2014/0089741 A1
(43) Pub. Date: Mar. 27, 2014

(54) DATA TRANSITION TRACING APPARATUS, DATA TRANSITION TRACING METHOD AND STORAGE MEDIUM STORING DATA TRANSITION TRACING PROGRAM

(71) Applicant: NEC Corporation, Tokyo (JP)

(72) Inventor: TAKAYUKI KADOWAKI, Tokyo (JP)

(73) Assignee: NEC Corporation, Tokyo (JP)

(21) Appl. No.: 14/036,761

(22) Filed: Sep. 25, 2013

(30) Foreign Application Priority Data
Sep. 25, 2012 (JP) 2012-210252

(51) Int. Cl. G06F 11/36

(52) U.S. Cl. CPC G06F 11/3636
USPC 714/45

(57) ABSTRACT

Disclosed is a data transition tracing apparatus capable of solving the problem on tracing an error for debugging.

The apparatus includes an execution unit that sequentially executes sets of information processing (IP), each of which receives a plurality of chunks which are sets of data records and outputs output chunks associated with the input chunk, onto the respective input chunks and chunk division unit that, with respect to each of the second and later sets of the IP individually, rearranges the output chunk outputted by the set of the IP located at a preceding stage (PS) into the input chunk to be inputted to the set of the IP in question located at a succeeding stage of the PS and stores chain information, which shares any of the data records and associates the input chunk with the output chunk outputted by the set of the IP located at the PS.

This application is based upon and claims the benefit of priority from Japanese Patent Application No. 2012-210252, filed on Sep. 25, 2012, the disclosure of which is incorporated herein in its entirety by reference.

### TECHNICAL FIELD

The present invention relates to a data transition tracing apparatus or the like which, in case an error has occurred during data processing, traces the error for debugging.

### BACKGROUND ART

In recent computer systems, both number of lines included in software operating and amount of data to be processed have become extremely large. Accordingly, a difficulty of debugging work performed when an error occurs during data processing owing to a bug in software or input data has become higher year by year, and thus required is technology for performing the debugging work efficiently.

As a technology for performing the debugging work efficiently, for example, well known generally is a technology such as of tracing execution of a program by setting some number of checkpoints in the midstream of program execution and, if an error occurs, re-executing the program from a checkpoint just prior to the error occurrence.

As a technology related to such a technology, Japanese Patent Application Laid-Open No. 1995-311693 discloses a system which is a computer system of executing a program while acquiring checkpoints and, when occurrence of a program failure is detected, switches the program to a debug mode and restarts the program from the corresponding checkpoint.

Further, Japanese Patent Application Laid-Open No. 2009-86808 discloses a system which enables efficient debugging by a plurality of operators, through correctly recording information related to checkpoints, that about a program execution status related to the checkpoints and that about a bug, and making them shared among the operators.

Still further, Japanese Patent Application Laid-Open No. 2009-9201 discloses, in relation to a tracing control system used for grasping a sequence of program execution, a system which grasps a sequence of tasks managed by the function ID of a source program or an OS by suppressing circuit complication due to a tracing condition setting circuit and increase in physical size of a tracing memory.

### SUMMARY

For example, in a case where an error occurred in data processing in which input data is processed by a plurality of steps and a final output result is obtained by sequentially repeating a process where a result outputted by a job step of one stage is processed by a following stage's job step, it can not allege that a problem exists in the processing by a job step in which the error occurred.

For example, if a reason of an error exists in any one of records included in input data, it means that the error is due to generation of data having caused the error by the job step of any one of preceding stages which generated the input data inputted to the job step in which the error has occurred.

In the above-described case of data processing, debugging work can be made efficient by narrowing down records in input data having a possibility of error existence, but the systems disclosed in Japanese Patent Application Laid-Open No. 1995-311693, Japanese Patent Application Laid-Open No. 2009-86808 and Japanese Patent Application Laid-Open No. 2009-9201 have no function to narrow down such records.

The main objective of the present invention is to provide a data transition tracing apparatus, a data transition tracing method and a data transition tracing program which solve the above-described problem.

A data transition tracing apparatus according to an exemplary aspect of the invention includes, an execution unit that sequentially executes sets of information processing, each of which receives a plurality of chunks which are sets of data records and outputs output chunks associated with the input chunk, onto the respective input chunks; and a chunk division unit that, with respect to each of the second and later sets of the information processing individually, rearranges the output chunk outputted by the set of the information processing located at a preceding stage into the input chunk to be inputted to the set of the information processing in question located at a succeeding stage of the preceding stage and stores, into a chain storage unit, chain information which shares any of the data records and associates the input chunk with the output chunk outputted by the set of the information processing located at the preceding stage.

A data transition tracing method according to an exemplary aspect of the invention includes, by an information processing apparatus, sequentially executing sets of information processing, each of which receives a plurality of chunks which are sets of data records and outputting output chunks associated with the input chunk, onto the respective input chunks; and by the information processing apparatus, with respect to each of the second and later sets of the information processing individually, rearranging the output chunk outputted by the set of the information processing located at a preceding stage into the input chunk to be inputted to the set of the information processing in question located at a succeeding stage of the preceding stage and storing, into a storage unit, chain information which shares any of the data records and associating the input chunk with the output chunk outputted by the set of the information processing located at the preceding stage.

A non-transitory computer-readable medium according to an exemplary aspect of the invention stores a computer program causing a computer to realize an execution function that sequentially executes sets of information processing, each of which receives a plurality of chunks which are sets of data records and outputs output chunks associated with the input chunk, onto the respective input chunks, and a chunk division function that, with respect to each of the second and later sets of the information processing individually, rearranges the output chunk outputted by the set of the information processing located at a preceding stage into the input chunk to be inputted to the set of the information processing in question located at a succeeding stage of the preceding stage and stores, into a storage unit, chain information which shares any of the data records and associates the input chunk with the output chunk outputted by the set of the information processing located at the preceding stage.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of a data transition tracing apparatus of a first exemplary embodiment of the present invention;

FIGS. 2A to 2B collaboratively show a flow chart illustrating operation of storing chain information in the first exemplary embodiment of the present invention;

FIGS. 3A to 3B collaboratively show a flow chart illustrating operation of storing and displaying tracing information in the first exemplary embodiment of the present invention;

FIG. 4 is an example of data transition in a data processing case 1 in the first exemplary embodiment of the present invention;

FIG. 5 is an example of a configuration of chain information in the data processing case 1 in the first exemplary embodiment of the present invention;

FIG. 6 is an example of a configuration of tracing information in the data processing case 1 in the first exemplary embodiment of the present invention;

FIG. 7 is an example of data transition in a data processing case 2 in the first exemplary embodiment of the present invention;

FIG. 8 is an example of a configuration of chain information in the data processing case 2 in the first exemplary embodiment of the present invention;

FIG. 9 is an example of a configuration of tracing information in the data processing case 2 in the first exemplary embodiment of the present invention;

FIG. 10 is an example of tracing information displayed on a display unit in the first exemplary embodiment of the present invention;

FIG. 11 is a block diagram showing a configuration of a data transition tracing apparatus of a second exemplary embodiment of the present invention;

FIGS. 12A to 12B collaboratively show an example of operation of narrowing down error points by a tracing control unit in a data processing case 2 in the second exemplary embodiment of the present invention;

FIG. 13 is a block diagram showing a configuration of a data transition tracing apparatus in a third exemplary embodiment of the present invention; and

FIG. 14 is a block diagram showing a configuration of an information processing apparatus capable of implementing the data transition tracing apparatuses of the first to the third exemplary embodiments of the present invention.

### EXEMPLARY EMBODIMENT

Hereinafter, exemplary embodiments of the present invention will be described in detail with reference to drawings.

### First Exemplary Embodiment

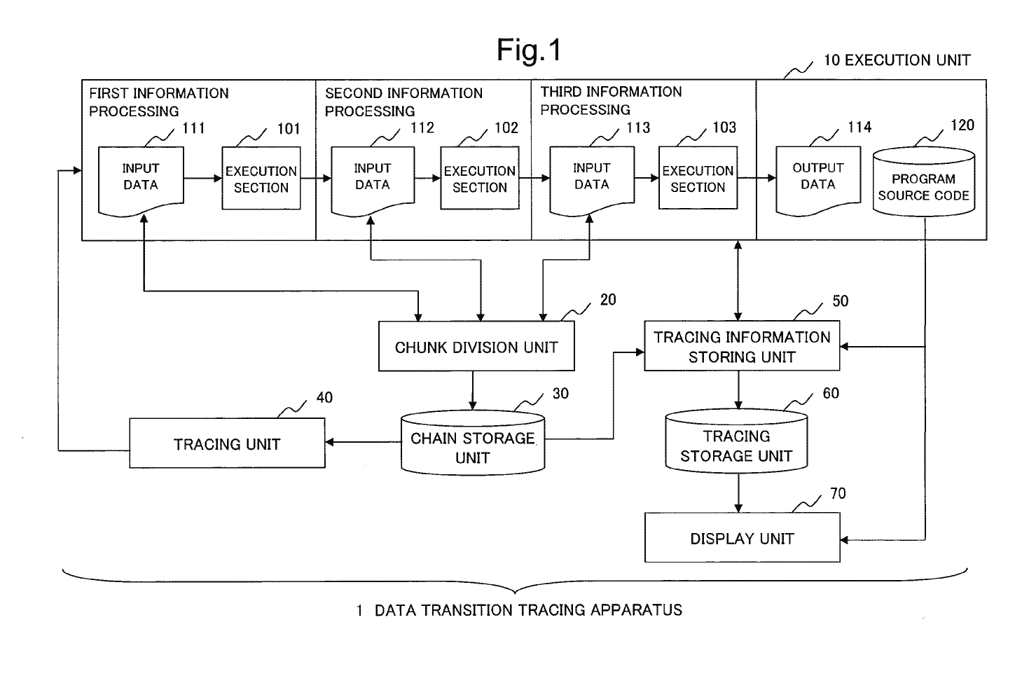

FIG. 1 is a block diagram showing a configuration of a data transition tracing apparatus of the present exemplary embodiment. The data transition tracing apparatus 1 of the present exemplary embodiment has an execution unit 10, a chunk division unit 20, a chain storage unit 30, a tracing unit 40, a tracing information storing unit 50, a tracing storage unit 60 and a display unit 70.

The execution unit 10 has sets of information processing. That is, the execution unit 10 has an execution section 101 for a first set of information processing, an execution section 102 for a second set of information processing, an execution section 103 for a third set of information processing, input data 111 for the first set of information processing, input data 112 for the second set of information processing, input data 113 for the third set of information processing, output data 114 and a program source code 120.

In this embodiment and following embodiments, the description “sets of information processing” means a configuration that same or different information processing are connected in series as shown in FIG. 1. That is, each of first to third information processing in FIG. 1 is an information processing step representing a certain processing.

The execution section 101 receives the input data 111, performs data processing on it and outputs the processing result. The execution section 102 receives the input data 112 generated by the chunk division unit 20 rearranging the result outputted from the execution section 101. The execution section 102 performs data processing on the input data 112 and outputs the processing result. The execution section 103 receives the input data 113 generated by the chunk division unit 20 rearranging the result outputted from the execution section 102. The execution section 103 performs data processing on the input data 113 and outputs the output data 114.

The program source code 120 is a source code constituting a software program (computer program) which executes the data processing performed by the execution sections 101, 102 and 103.

The chunk division unit 20 divides each of the input data 111, 112 and 113 into chunks, each of which is a set of input data records included in the input data and is set to include a predetermined number of records (hereafter, referred to as a chunk size).

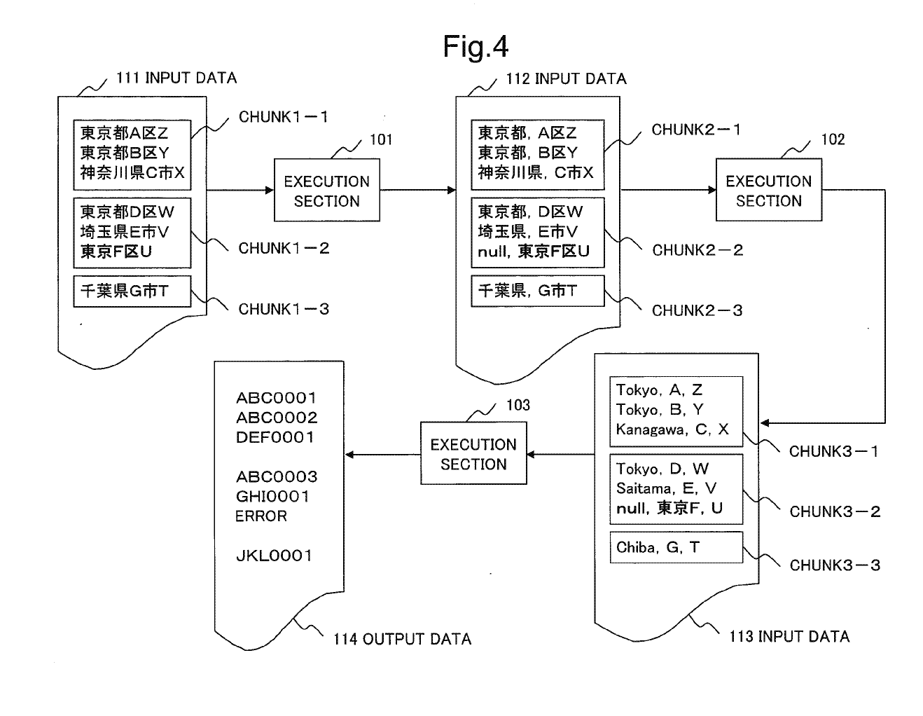

FIG. 4 shows an example of the division of the input data 111, 112 and 113 into chunks performed by the chunk division unit 20, in a data processing case 1.

In the data processing case 1 shown in FIG. 4, the input data 111 includes seven input data records.

The chunk division unit 20 divides the input data 111 into chunks, setting the chunk size at three, and gives each of the chunks a chunk ID (identifier) enabling identification of the chunk. In the case of the present data processing case 1, a chunk 1-1 includes the first to third input data records, a chunk 1-2 the fourth to sixth and a chunk 1-3 the seventh.

The execution section 101 performs a process of separating an address represented by each of the input data records into a part representing a prefecture and that representing a ward or city and unit(s) of an administrative area following there of. In the sixth input data record of the input data 111, because of a data input failure, the character “ [symbol] ” meaning prefecture is lost from [symbol] (Tokyo prefecture). As a result, the execution section 101 cannot recognize which prefecture the input data record is relevant to. The execution section 101 outputs the data record after putting “null” into its prefecture part, but does not treat the data record as an error. In accordance with the content indicated by the chunk division unit 20, the execution section 101 executes the above-described process on each of the chunks individually and outputs a result of the execution for each of the chunks.

By rearranging the results (not illustrated in the drawing) outputted by the execution section 101, the chunk division unit 20 generates the input data 112. The chunk division unit 20 newly divides the input data 112 into chunks, setting the chunk size at three, and gives the resulting chunks chunk IDs from 2-1 to 2-3 which enable identification of the respective chunks. The chunk 2-1 includes the first to third data records outputted from the execution section 101. The chunk 2-2 includes the fourth to sixth data records. The chunk 2-3 includes the seventh data record.

The execution section 102 performs a process of converting a prefecture name represented by each input record from that in Chinese characters to that in alphabet and separating a part representing the ward or city and unit(s) of the administrative area following there of in the record, into a part for the ward or city and that for the followings. The execution section 102 does not treat the sixth input data record including “null” as an error. In accordance with the content indicated by the chunk division unit 20, the execution section 102 executes the above-described process on each of the chunks individually and outputs a result of the execution for each of the chunks.

By rearranging the results (not illustrated in the drawing) outputted by the execution section 102, the chunk division unit 20 generates the input data 113. The chunk division unit 20 newly divides the input data 113 into chunks, setting the chunk size at three, and gives the resulting chunks chunk IDs from 3-1 to 3-3 which enable identification of the respective chunks. The chunk 3-1 includes the first to third data records outputted from the execution section 102. The chunk 3-2 includes the fourth to sixth input data records. The chunk 3-3 includes the seventh input data record.

The execution section 103 performs a process of coding each of the input data records. Because the execution section 103 cannot perform coding on the sixth input data record including “null”, it outputs it as an error into the output data 114. In accordance with the content indicated by the chunk division unit 20, the execution section 103 executes the above-described process on each of the chunks individually and outputs a result of the execution for each of the chunks.

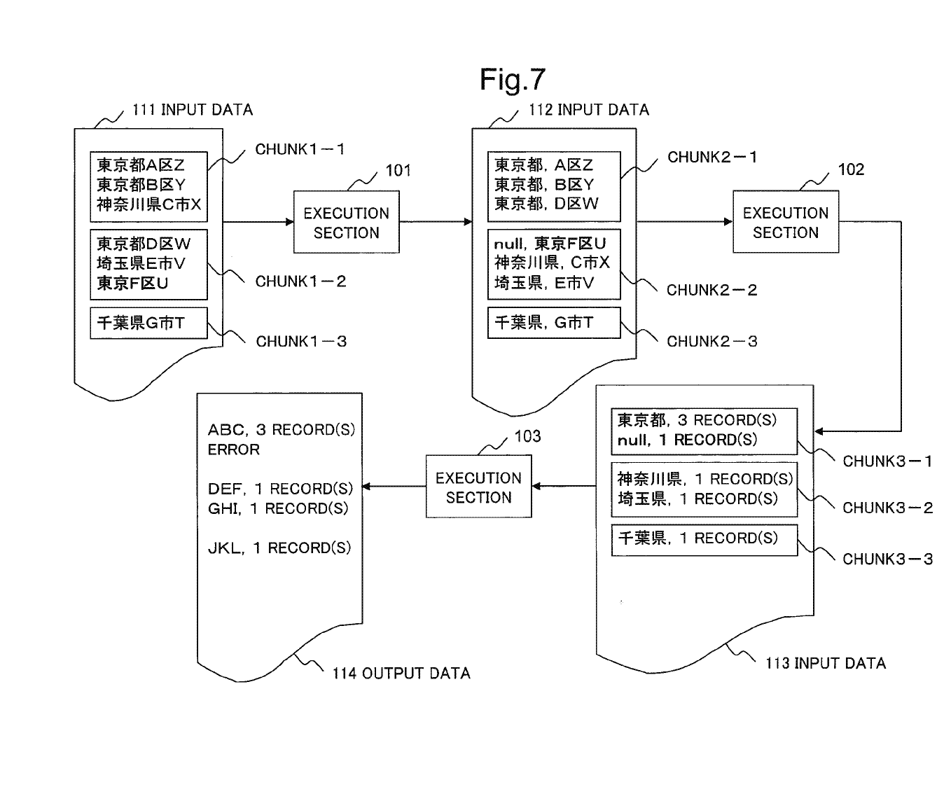

FIG. 7 shows another example of the division of the input data 111, 112 and 113 into chunks performed by the chunk division unit 20, which is in a data processing case 2 different from the data processing case 1 described above.

In the data processing case 2 shown in FIG. 7, the content subjected to data processing by the execution section 101 is the same as that in the data processing case 1. Differently from in the data processing case 1, the execution section 102 performs, on the input data records sorted by the chunk division unit 20 setting prefecture names as the sort key, a data processing of counting the number of input data records relevant to each prefecture.

In the data processing case 2, because of the addition of the sort process, the order of inputting the input data records to the execution section 102 does not become the same as the order of outputting them from the execution section 101 like in the data processing case 1. The input data records included in the input data 112 are inputted to the execution section 102 in the order the first, second, fourth, sixth, third, fifth and seventh records, if the records are expressed by the respective numbers in the order of their being outputted from the execution section 101.

The chunk division unit 20 gathers into a chunk 2-1 input data records relevant to respective ones of the records which were firstly, secondly and fourthly outputted from the execution section 101, those relevant to the sixthly, thirdly and fifthly outputted records into a chunk 2-2, and that relevant to the seventhly outputted record into a chunk 2-3, and then inputs the chunks to the execution section 102.

The execution section 103 performs a process of coding a prefecture name represented by each of the input data records. The chunk division unit 20 inputs chunks 3-1 to 3-3, each with a chunk size of two, to the execution section 103. Because the execution section 103 cannot perform coding on the second input data record including “null”, it outputs it as an error into output data 114.

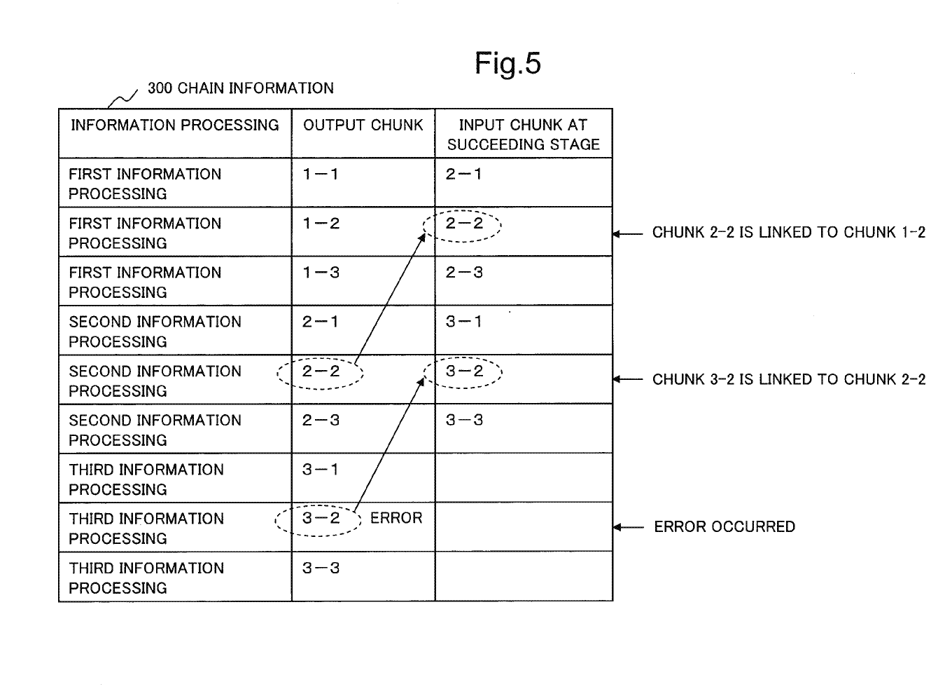

The chunk division unit 20 also performs, with respect to each of the execution sections, a process of associating each output chunk outputted by the execution section with input chunks inputted to the succeeding execution section including any of the data records included in the output chunk, and storing identification information enabling identification of the output and input chunks associated with each other into the chain storage unit 30. FIG. 5 shows an example of a configuration of chain information 300 stored in the chain storage unit 30, in the data processing case 1 described above.

It is indicated, for example, that all of data records included in the output chunk outputted as a result of the execution section 101 processing the chunk 1-1 are included in the chunk 2-1 inputted to the execution section 102.

With regard to the chunk 3-2, since an error occurs when the execution section 103 receives and processes it, the chunk division unit 20 registers the occurrence of an error into a chain record relevant to the chunk 3-2 in the chain information 300.

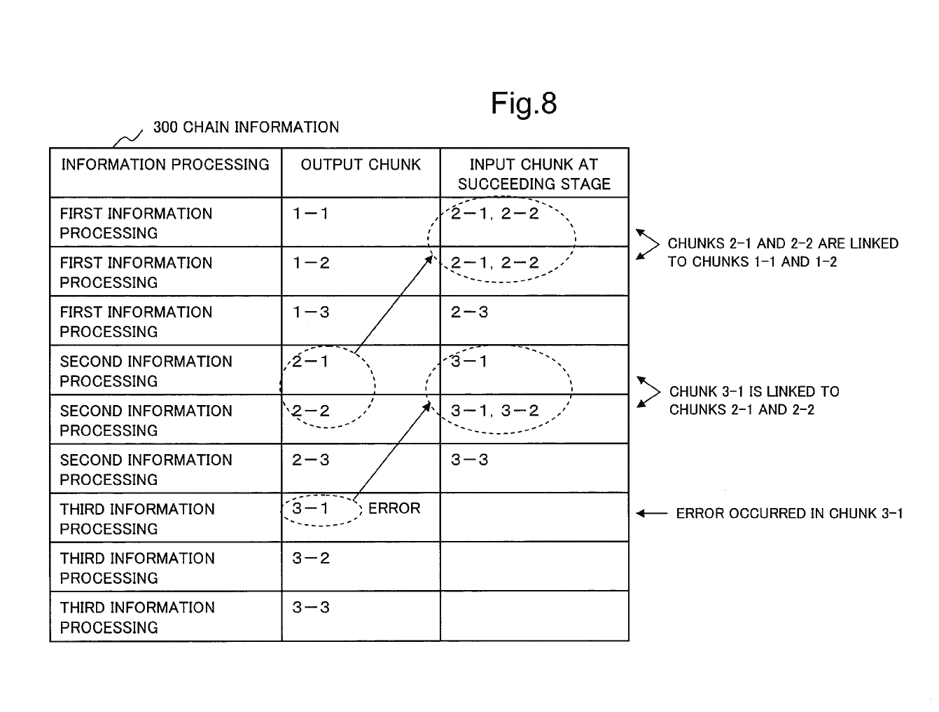

FIG. 8 shows an example of a configuration of chain information 300 stored in the chain storage unit 30, in the data processing case 2 described above. In this case, it is indicated, for example, that data records included in the output chunk outputted as a result of the execution section 101 processing the chunk 1-1 are included in either of the chunks 2-1 and 2-2 which are inputted to the execution section 102.

With regard to the chunk 3-1, since an error occurs when the execution section 103 receives and processes it, the chunk division unit 20 registers the occurrence of an error into a chain record relevant to the chunk 3-1 in the chain information 300.

Note, that as a method of storing chain information 300 by the chunk division unit 20, besides the one described above, there is another one which, with respect to each of the execution sections, associates each input chunk inputted to the execution section with an output chunk outputted by the preceding execution section having included any of the data records included in the input chunk, and storing identification information enabling identification of the input and output chunks associated with each other into the chain storage unit 30.

The tracing unit 40 traces chain information 300 stored in the chain storage unit 30 and thereby identifies a chunk in the input data 111 with a possibility of having connection to error occurrence.

In the case of the example in the data processing case 1 shown in FIG. 5, the tracing unit 40 confirms that a chunk designated by a chain record with an error indication given in its column for indicating an output chunk is the chunk 3-2. Next, referring to the chain records relevant to the execution section 102 located at the stage preceding the execution section 103, the tracing unit 40 searches for a chain record whose column for indicating an input chunk to the succeeding stage includes the chunk 3-2, and identifies that a value designated by an output chunk in a thus hit chain record is 2-2.

Further, referring to the chain records relevant to the execution section 101 located at the stage preceding the execution section 102, the tracing unit 40 searches for a chain record whose column for indicating an input chunk to the succeeding stage includes the value 2-2, and finally identifies that a value designated by an output chunk in a thus hit chain record is 1-2.

In the case of the example in the data processing case 2 shown in FIG. 8, the tracing unit 40 confirms that a chunk designated by a chain record with an error indication given in its column for indicating an output chunk is the chunk 3-1. Next, referring to the chain records relevant to the execution section 102 located at the stage preceding the execution section 103, the tracing unit 40 searches for a chain record whose column for indicating an input chunk to the succeeding stage includes the value 3-1, and identifies that values designated by an output chunk in a thus hit chain record are 2-1 and 2-2.

Further, referring to the chain records relevant to the execution section 101 located at the stage preceding the execution section 102, the tracing unit 40 searches for chain records whose column for indicating an input chunk to the succeeding stage includes the values 2-1 or 2-2, and finally identifies that values designated by output chunks in thus hit chain records are 1-1 and 1-2.

The data tracing information storing unit 50 collects from the execution unit 10 information necessary for data tracing on the processes where the execution unit 101 received one by one and performed data processing on the input records included in the chunk of the input data 111 identified by the tracing unit 40, and also the execution sections 102 and 103 subsequently received one by one and performed data processing on the input data records.

The information collected by the tracing information storing unit 50 includes, for each of relevant input data records, a value indicated by the input data record and identification information enabling identification of the execution section which processes the input data record. The information collected by the tracing information storing unit 50 also includes, for each of the relevant input data records, information on a program status at the time of processing the input data record and information on a program source file relevant to the processing of the input data record. The information collected by the tracing information storing unit 50 further includes, for each of the relevant input data records, a value indicated by the data record outputted as a result of the relevant execution section's processing the input data record, and does association information which associates the input data record with an output record outputted by the execution section located at the preceding stage.

Among the pieces of information described above, the information on a program status at the time of processing an input data record is collected by the tracing information storing unit 50 while the relevant execution section is processing the input data record, from a log outputted by the execution unit 10.

The information on a program source file relevant to the processing of the input data record is collected by the tracing information storing unit 50 from the program source code 120. In the program source code 120, which part of the code a program executed by each execution section corresponds to is generally commented, and therefore the tracing information storing unit 50 collects the above-mentioned source file information by referring to such comment lines in the program source code 120 using identification information on an execution section as a search key.

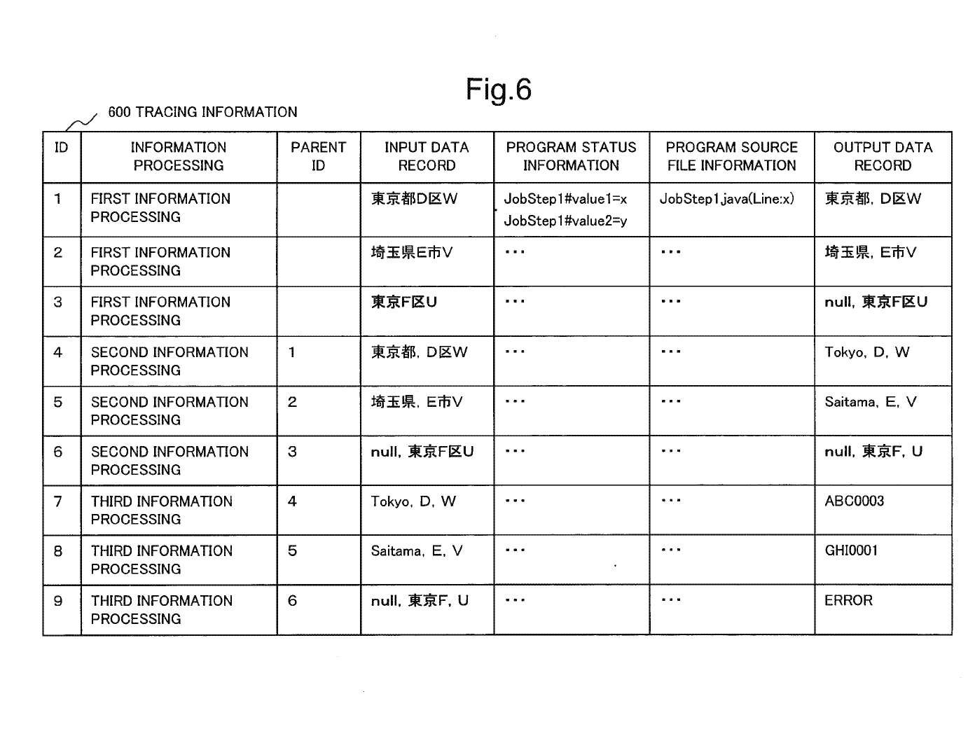

The tracing information storing unit 50 outputs the pieces of information collected as above to the tracing storage unit 60, as tracing information in which they are associated with each other using the value indicated by the relevant input data record as a key. FIG. 6 shows an example of a configuration of tracing information 600 in the data processing case 1 described above.

As shown in FIG. 6, an ID is given to each tracing record in the tracing information 600 by the tracing information storing unit 50. Parent IDs in FIG. 6 each are association information described above, which associates the input data record accompanied with the parent ID with an output data record outputted by the execution section located at the preceding stage.

For example, a parent ID of 6 is given to the tracing record with an ID of 9 whose output data record is error, in the tracing information 600. In the tracing information 600, the value indicated by the input data record in the tracing record with an ID of 9 and that by the output data record in the tracing record with an ID of 6 are both “null, [symbol] F, U”. That is, the values of the ID and the parent ID associated with an input record relates information on the processing result by the execution section relevant to the input record with information on the processing result by another execution section located at the stage preceding the execution section.

In the case of the data processing case 1 shown in FIG. 6, a parent ID of 6 is given to the tracing record with an ID of 9 indicating an error occurrence in its output data record, and a parent ID of 3 is given to the tracing record with an ID of 6. A person in charge of debugging, who uses the execution unit 10, traces the tracing records with respective IDs of 9, 6 and 3 in the tracing information 600 step by step, thus finding that the value indicated by the input data record in the tracing record with an ID of 3 is “ [symbol] F [symbol] U”, and thereby identifies the missing of “ [symbol] ” from “ [symbol] ” as the cause of the error occurrence.

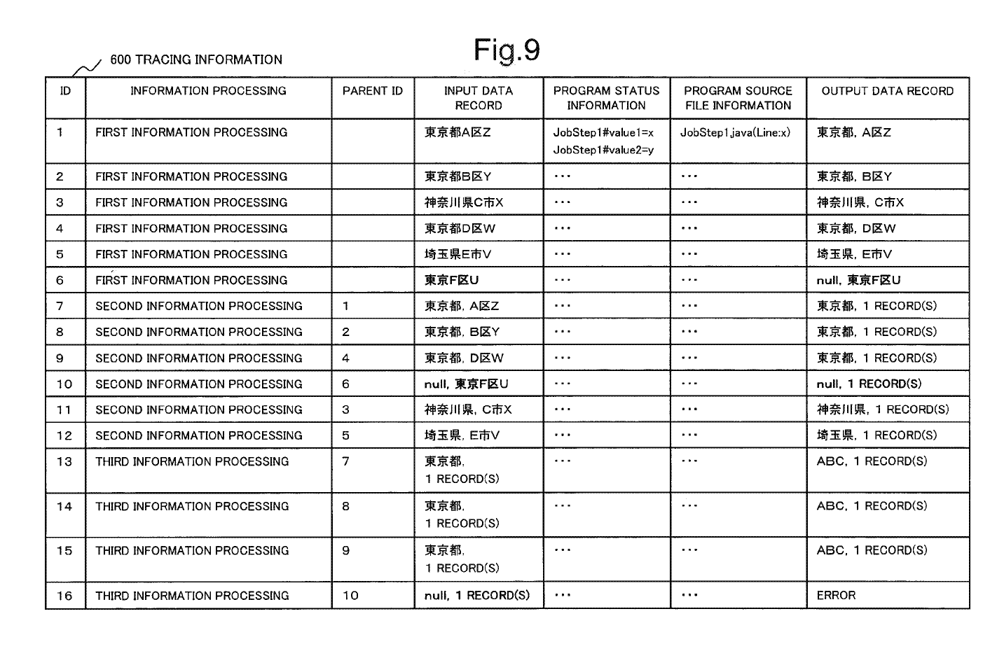

FIG. 9 shows an example of a configuration of tracing information 600 in the data processing case 2 described above. In this case, a parent ID of 10 is given to the tracing record with an ID of 16 indicating error occurrence in its output data record, and an parent ID of 6 is given to the tracing record with an ID of 10. A person in charge of debugging, who uses the execution unit 10, traces the tracing records with respective IDs of 16, 10 and 6 in the tracing information 600 step by step, thus finding that the value indicated by the input data record in the tracing record with an ID of 6 is “ [symbol] F [symbol] U”, and thereby identifies the missing of “ [symbol] ” from “ [symbol] ” as the cause of the error occurrence.

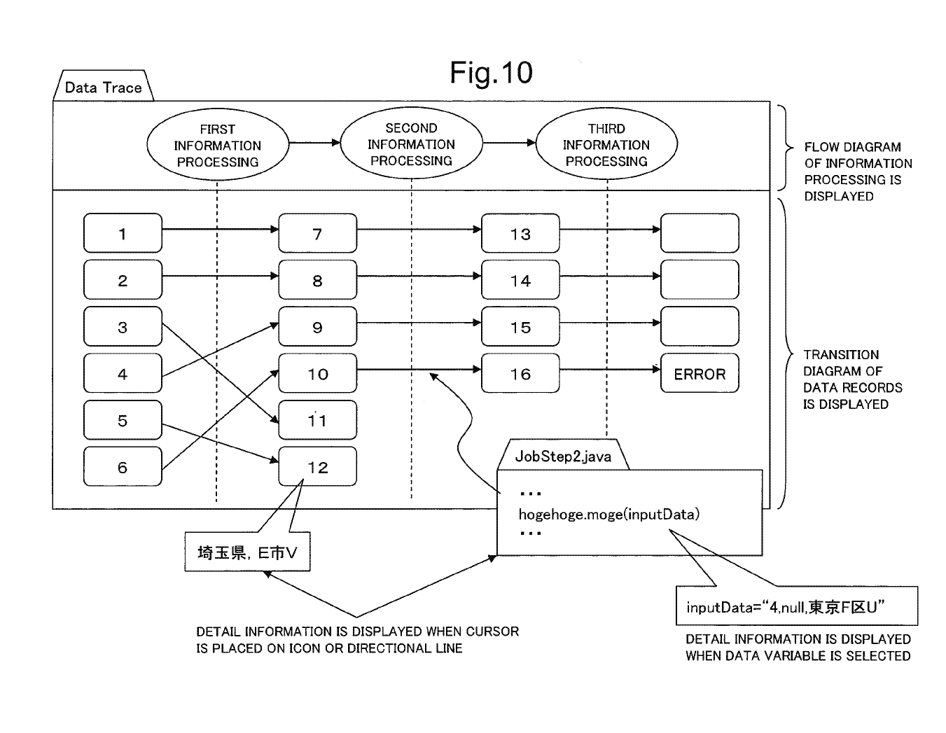

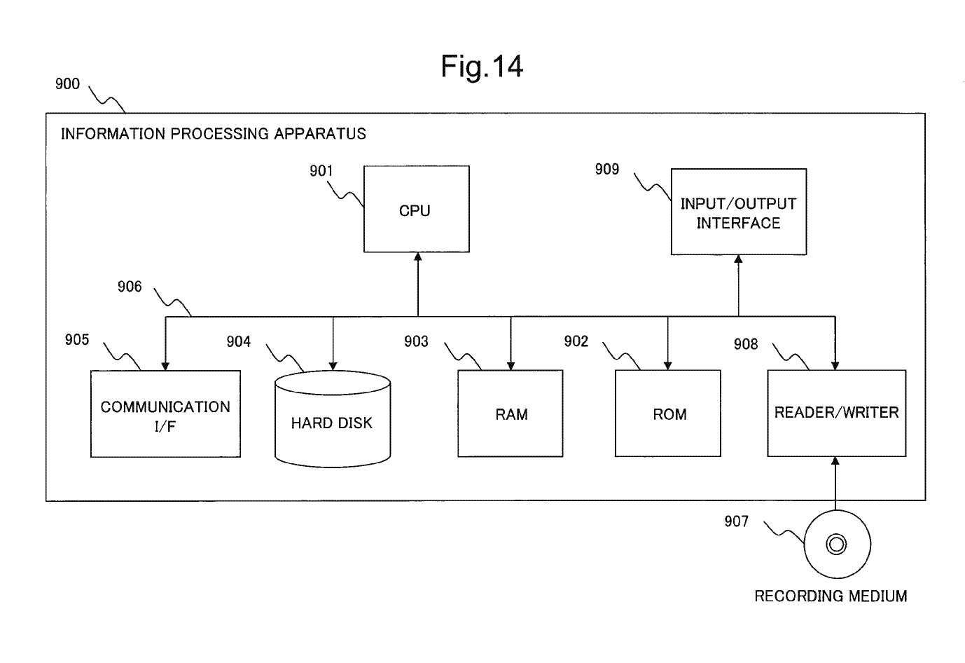

The display unit 70 displays tracing information 600 graphically on the screen. FIG. 10 shows an example of a screen image displayed by the display unit 70. It is an image of when the tracing information 600 in the above-described data processing case 2 is displayed on the screen. This screen image is displayed, for example, on an input/output interface 909 in a hardware environment shown as an example in FIG. 14.

The display unit 70 displays a flow chart of executing the set of information processing in the upper area of the display screen, and a transition diagram of the data records in the lower area.

In the transition diagram of the data records, icons with respective numbers from 1 to 16 displayed on them respectively represent the input data records with respective IDs from 1 to 16 included in the tracing information 600 shown in FIG. 9. There is shown that, for example, in the tracing information 600, the input data record with an ID of 6 makes a transition to the input data record with an ID of 10, as a result of being processed by the execution section 101. The input data record with an ID of 10 makes a transition to the input data record with an ID of 16, as a result of being processed by the execution section 102. Then, the input data record with an ID of 16 yields an output data indicating an error, as a result of being processed by the execution section 103.

When a person in charge of debugging places a cursor onto the icon representing an input data record on the display screen (that is, when the difference in coordinates between the cursor and the icon becomes equal to or smaller than a predetermined value), the display unit 70 displays detail information on the input data record. For example, for the icon with the number 12 displayed on it, the display unit 70 displays information “ [symbol] , E [symbol] V”.

When the person in charge of debugging places the cursor onto a directional line connecting an icon to another one on the display screen (that is, when the difference in coordinates between the cursor and the directional line becomes equal to or smaller than a predetermined value), the display unit 70 displays the source file information and program status information on a program which processes the input data record represented by the icon from which the directional line originates. For example, for the directional line from the icon 10 to the icon 16, the display unit 70 displays the program status information and program source file information included in the record with an ID of 10 in the tracing information 600 shown in FIG. 9.

The person in charge of debugging moves the cursor by the use of the input/output interface 909 shown as an example in FIG. 14. As an example of an input device to be used as the input/output interface 909, a mouse or a touch panel will be mentioned.

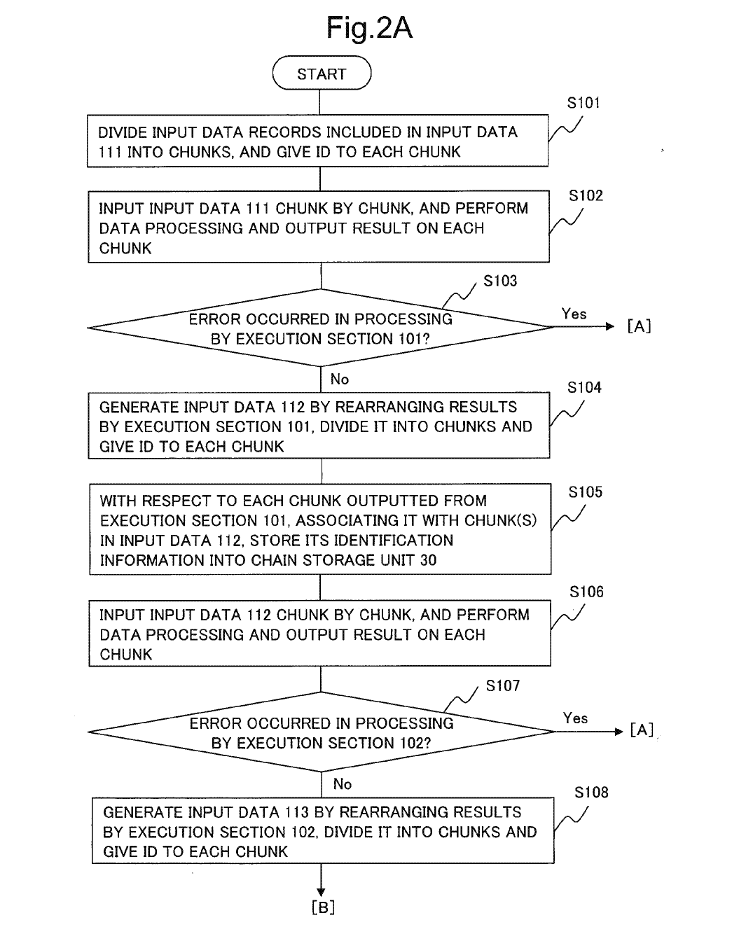

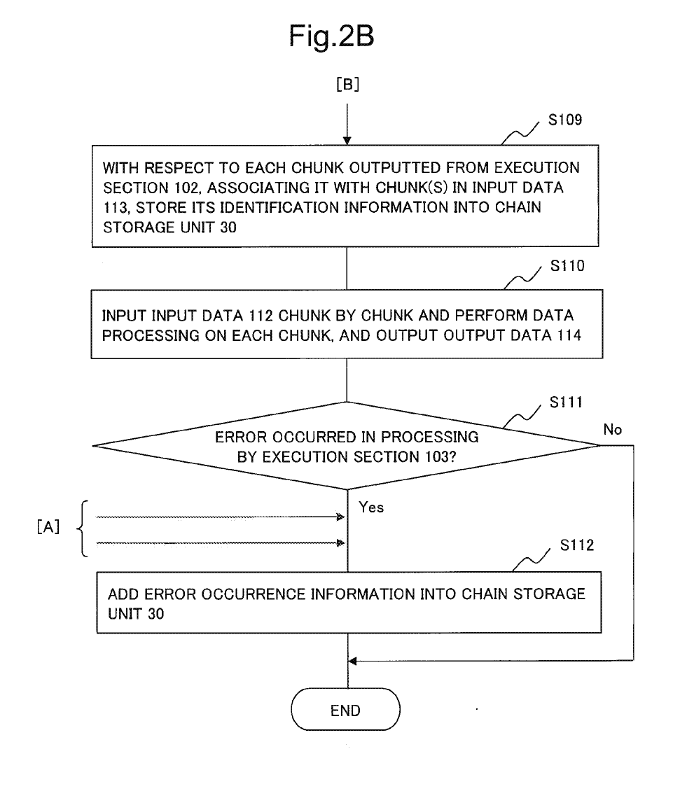

Next, detail description will be given of operation of storing the chain information 300, in the present exemplary embodiment, with reference to a flow chart shown collaboratively in FIGS. 2A to 2B.

The chunk division unit 20 divides input data records included in the input data 111 into chunks of a predetermined chunk size, and gives a chunk ID to each of the chunks (S101). The execution section 101 receives the input data 111 chunk by chunk and performs data processing on each of the chunks individually, and outputs the result for each of them (S102).

If an error occurred in the processing performed by the execution section 101 (Yes at S103), the chunk division unit 20 adds information on the error occurrence into the chain storage unit 30 (S112), and then the whole process is ended. If no error occurred in the processing performed by the execution section 101 (No at S103), the chunk division unit 20 generates the input data 112 by rearranging the results outputted by the execution section 101, divides the input data 112 into chunks of a predetermined chunk size, and gives a chunk ID to each of the chunks (S104).

The chunk division unit 20 associates each of the chunks outputted from the execution section 101 with a chunk, among the chunks putted into the input data 112, which includes any of the data records included in the outputted chunk, and stores identification information enabling identification of each of the chunks associated with each other into the chain storage unit 30 (S105). The execution section 102 receives the input data 112 chunk by chunk and performs data processing on each of the chunks individually, and outputs the result for each of them (S106).

If an error occurred in the processing performed by the execution section 102 (Yes at S107), the chunk division unit 20 adds information on the error occurrence into the chain storage unit 30 (S112), and then the whole process is ended. If no error occurred in the processing performed by the execution section 102 (No at S107), the chunk division unit 20 generates the input data 113 by rearranging the results outputted by the execution section 102, divides the input data 113 into chunks of a predetermined chunk size, and gives a chunk ID to each of the chunks (S108).

The chunk division unit 20 associates each of the chunks outputted from the execution section 102 with a chunk, among the chunks putted into the input data 113, which includes any of the data records included in the outputted chunk, and stores identification information enabling identification of each of the chunks associated with each other into the chain storage unit 30 (S109). The execution section 103 receives the input data 113 chunk by chunk and performs data processing on each of the chunks individually, and outputs the output data 114 (S110).

If an error occurred in the processing performed by the execution section 103 (Yes at S111), the chunk division unit 20 adds information on the error occurrence into the chain storage unit 30 (S112), and then the whole process is ended. If no error occurred in the processing performed by the execution section 103 (No at S111), the whole process is ended.

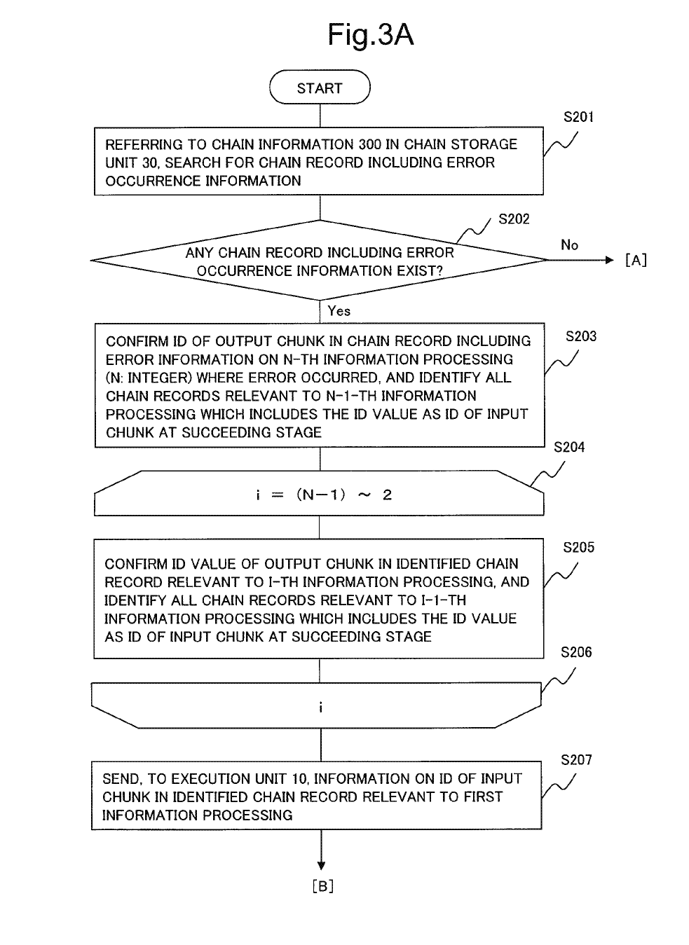

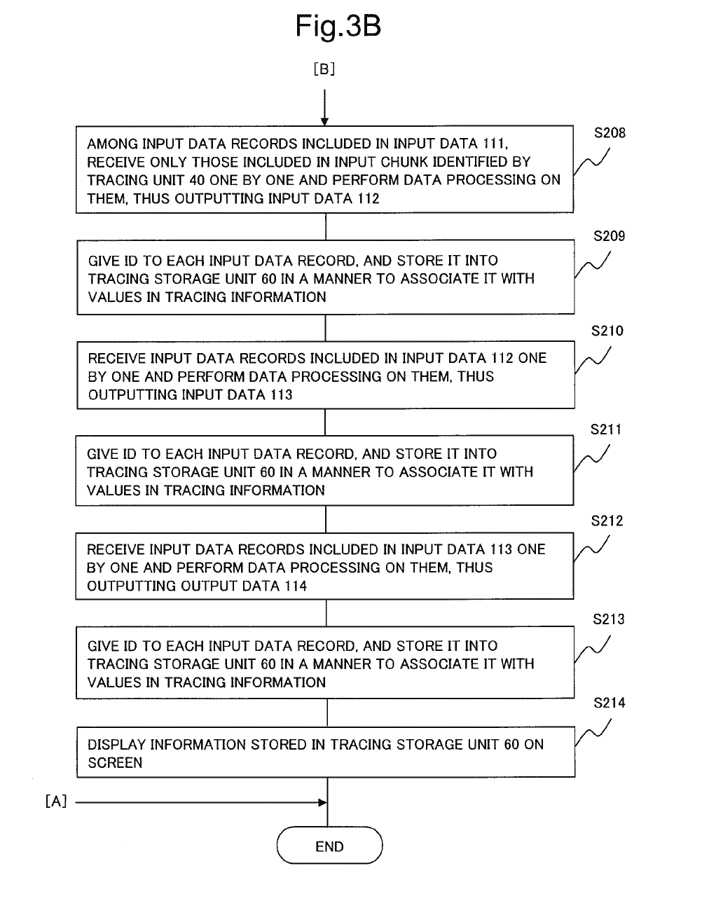

Next, detail description will be given of operation of storing and displaying the tracing information 600, in the present exemplary embodiment, with reference to a flow chart shown collaboratively in FIGS. 3A to 3B.

Referring to the chain information 300 stored in the chain storage unit 30, the tracing unit 40 searches for a chain record including error occurrence information (S201). If no chain record including error occurrence information is found (No at S202), the whole process is ended. If a chain record including error occurrence information is found (Yes at S202), the tracing unit 40 confirms the value indicated by the ID for identifying an output chunk included in the chain record which includes error occurrence information relevant to the N-th set of information processing (N is an integer) where the error occurred, and identifies all chain records relevant to the N-1-th set of information processing which each include the confirmed value as an ID for identifying an input chunk for the succeeding stage (S203).

The data transition tracing apparatus 1 enters a loop process where an integer i is decreased from N-1 to 2 one by one (S204). The tracing unit 40 confirms the value indicated by the ID for identifying the output chunk included in an identified chain record relevant to the i-th set of information processing, and identifies all chain records relevant to the i-1-th set of information processing which each include the confirmed value as an ID for identifying an input chunk for the succeeding stage (S205), and then the process returns to S204 (S206).

The tracing unit 40 sends to the execution unit 10 the ID values for identifying the respective input chunks included in thus identified chain records relevant to the first set of information processing (S207). The execution section 101 receives, among the input data records included in the input data 111, only those included in the input chunks identified by the tracing unit 40 one by one, performs data processing on each of them, and thus outputs input data 112 (S208).

The tracing information storing unit 50 gives an ID to each of the input data records, and stores the ID into the tracing storage unit 60 in a manner to associate it with identification information for identifying the execution section 101, the value indicated by the input data record, program status information, program source file information and the value indicated by the relevant output data record (S209). The execution section 102 receives the input data records included in the input data 112 one by one, performs data processing on each of them, and thus outputs input data 113 (S210).

The tracing information storing unit 50 gives an ID to each of the input data records, and stores the ID into the tracing storage unit 60 in a manner to associate it with identification information for identifying the execution section 102, the value indicated by the parent ID, the value indicated by the input data record, program status information, program source file information and the value indicated by the relevant output data record (S211). The execution section 103 receives the input data records included in the input data 113 one by one, performs data processing on each of them, and thus outputs output data 114 (S212).

The tracing information storing unit 50 gives an ID to each of the input data records, and stores the ID into the tracing storage unit 60 in a manner to associate it with identification information for identifying the execution section 103, the value indicated by the parent ID, the value indicated by the input data record, program status information, program source file information and the value indicated by the relevant output data record (S213). The display unit 70 displays on its screen the tracing information 600 stored in the tracing storage unit 60 (S214), and the whole process is ended.

The present exemplary embodiment has the effect of making it possible to perform efficient debugging work by narrowing down error development paths when an error occurred in data processing. It is because, firstly, the chunk division unit 20 divides pieces of input data inputted to the respective execution sections in the execution unit 10 each into chunks, generates chain information associating a chunk with another one, and stores it into the chain storage unit 30. Secondly, on the basis of the chain information, the tracing unit 40 identifies a chunk with a possibility of being the cause of an error occurrence, and the tracing information storing unit 50 collects from the execution unit 10 tracing information on one-by-one data processing of the input data records included in the identified chunk by the execution unit 10 and stores it into the tracing storage unit 60.

When an error occurred in an apparatus processing a huge amount of data, debugging work for tracing a cause of the error occurrence is a difficult task. For example, in the case of a batch process including a plurality of steps, because each step of the process is performed on data gathered in a lump, it is usually difficult to trace a relationship between the data across the steps.

To deal with this problem, by generating chain information associating pieces of data inputted with respective ones of a plurality of steps included in the data processing to each other, the debugging work can be made to be efficient.

However, if the above-mentioned chain information is generated on relationships between data records individually, its information amount becomes huge. In the present exemplary embodiment, since chain information generated by the chunk division unit 20 is information associating chunks gathering a plurality of data records in a lump with each other, its information amount can be reduced.

Then, by tracing back a path associating chunks with each other indicated by the chain information, the tracing unit 40 can identify a chunk inputted to the execution unit 10 with a possibility of being the cause of an error occurrence. As a result of generation by the tracing information storing unit 50 of tracing information on one-by-one reception and processing, performed by the execution unit 10, of only input data records included in an input chunk with a possibility of being the cause of an error occurrence, a person in charge of debugging becomes able to perform efficient debugging work.

Further, depending on the specification of data processing performed by the execution unit 10, it is possible that intermediate data generated in the data processing, such as the input data 112 and 113, is present in a memory within the execution unit 10 only during the data processing and is erased when the data processing is ended. In the present exemplary embodiment, the tracing information storing unit 50 stores also information on such intermediate data into the tracing storage unit 60 as tracing information. In addition, since tracing information in the present exemplary embodiment includes also program status information and program source file information on a program for processing each data record, the efficiency of debugging is further improved.

Furthermore, in the present exemplary embodiment, since the display unit 70 graphically displays the tracing information on its screen and accordingly a person in charge of debugging can easily recognize the content of the tracing information, it becomes possible to further improve the efficiency of debugging work.

### Second Exemplary Embodiment

Next, description will be given in detail of a second exemplary embodiment, which is based on the first exemplary embodiment described above, with reference to a drawing. In the following description, to the same constituent units as that of the data transition tracing apparatus 1 in the first exemplary embodiment, the same signs as that in the first exemplary embodiment are given, and their duplicated explanations will be omitted in the present exemplary embodiment.

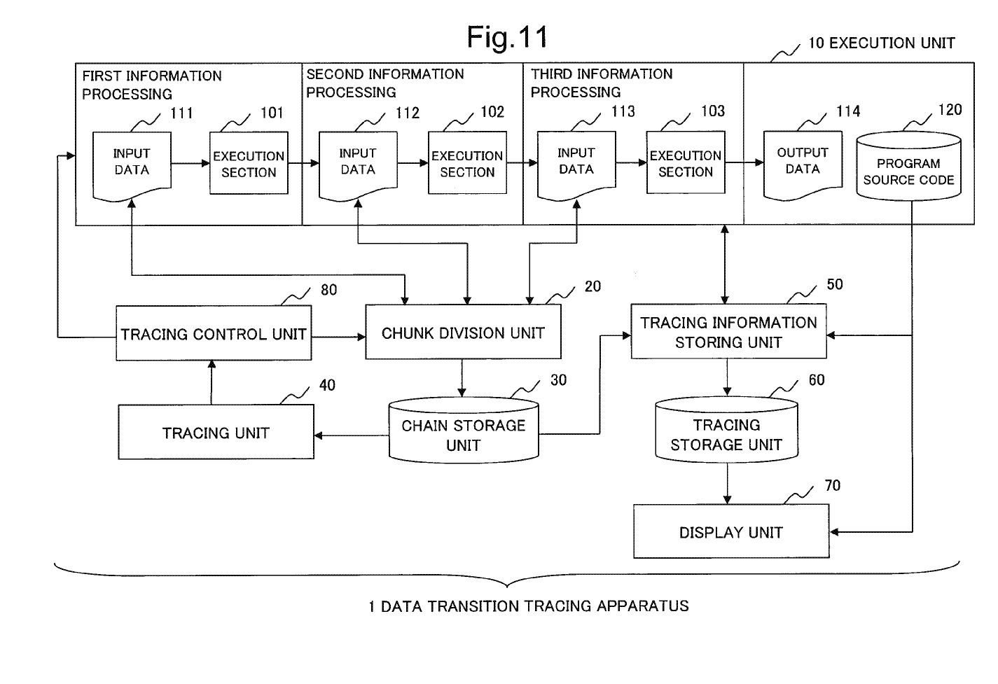

FIG. 11 is a block diagram showing a configuration of a data transition tracing apparatus of the second exemplary embodiment of the present invention. A data transition tracing apparatus 1 of the present exemplary embodiment is the same as that in the first exemplary embodiment except that it further has a tracing control unit 80, and operation of its units other than the tracing control unit 80 is also the same as that in the first exemplary embodiment.

If an error occurs when the execution unit 10 has performed processing once on all input data records, the tracing control unit 80 gathers data records included in chunks, included in input data 111, which are identified by the tracing unit 40 as those with a possibility of being the cause of the error occurrence. The tracing control unit 80 instructs the chunk division unit 20 to divide input data into chunks of a smaller chunk size than that in the first execution, and subsequently instructs the execution unit 10 to execute a second data processing on the data records gathered as above.

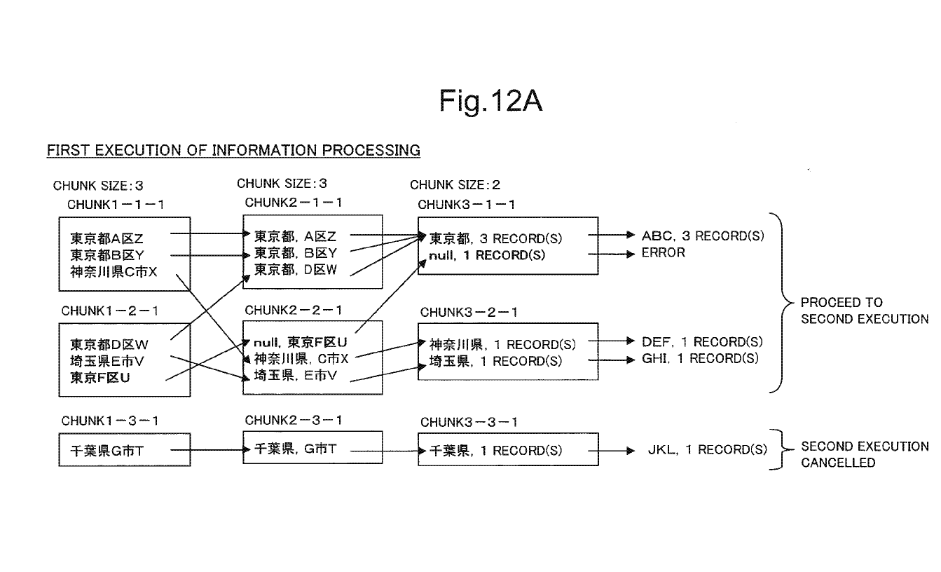

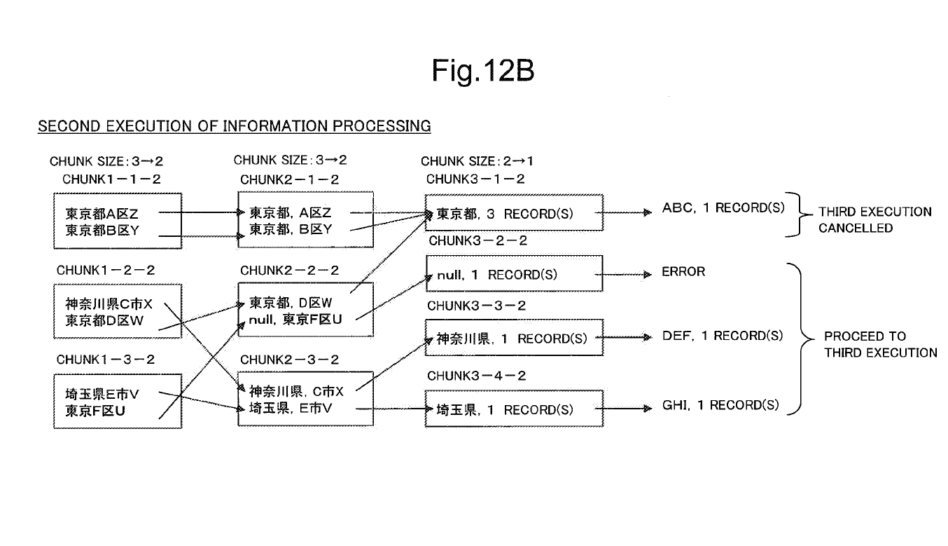

Performing the operation repeatedly, the tracing control unit 80 narrows down data records included in the input data 111 with a possibility of being the cause of the error occurrence. FIG. 12 shows an example of operation of narrowing down error points by the tracing control unit 80 of the present exemplary embodiment, in the data processing case 2 shown in the description of the first exemplary embodiment.

As a result of tracing operation by the tracing unit 40 on an error having occurred in the first execution of data processing on all of the input data records by the execution unit 10, the chunk 1-3-1 turns out not to be a cause of the error occurrence.

Receiving this result from the tracing unit 40, the tracing control unit 80 instructs the execution unit 10 to execute a second data processing on the six input data records included in the chunks 1-1-1 and 1-2-1. At that time, the tracing control unit 80 instructs the chunk division unit 20 to reduce the chunk sizes from that used in the execution of the first data processing.

On the basis of the content of the instructions by the tracing control unit 80, the chunk division unit 20 reduces the chunk size for input data 111 and 112 from three to two and that for input data 113 from two to one.

As a result of tracing operation performed by the tracing unit 40 after execution of the second data processing by the execution unit 10, the chunk 1-1-2 turns out not to be a cause of the error occurrence.

Receiving this result from the tracing unit 40, the tracing control unit 80 instructs the execution unit 10 to execute a third data processing on the four input data records included in the chunks 1-2-2 and 1-3-2. At that time, the tracing control unit 80 instructs the chunk division unit 20 to further reduce the chunk sizes from that used in the second data processing.

The tracing control unit 80 performs the above-described operation a predetermined number of times repeatedly.

Similarly to the first exemplary embodiment, the present exemplary embodiment has the effect of enabling efficient debugging work through efficiently narrowing down paths of an error occurrence when the error occurs in data processing. It is because: receiving a tracing result outputted by the tracing unit 40 after execution of a first data processing by the execution unit 10, the tracing control unit 80 gathers only input data records with a possibility of being the cause of error occurrence; the tracing control unit 80 instructs the execution unit 10 and the chunk division unit 20 to execute a second data processing on the gathered input data records using chunk sizes reduced from that used in the execution of the first data processing; and the same operation is repeated in a third and later data processing.

It is possible that, in the state just after the execution unit 10 has executed data processing once, the tracing unit 40 cannot sufficiently narrow down input data records with a possibility of being the cause of an error occurrence. In such a case, the size of tracing information generated later by the tracing information storing unit 50 is likely to become large.

If the chunk division unit 20 generates chain information, setting the chunk sizes at small values from the beginning, it is possible that the tracing unit 40 can fast narrow down input data records with a possibility of being the cause of an error occurrence, but in this case, the size of chain information becomes large.

In the present exemplary embodiment, the chunk division unit 20 starts generating chain information with the chunk sizes set at relatively large values at the beginning. Then, the tracing control unit 80 controls tracing operation to narrow down suspected data records with the chunk sizes being reduced step by step, and thereby the sizes of thus generated chain information and tracing information become small, and as a result, it becomes possible to further improve the efficiency of debugging work.

### Third Exemplary Embodiment

Next, a third exemplary embodiment of the present invention will be described in detail, with reference to a drawing.

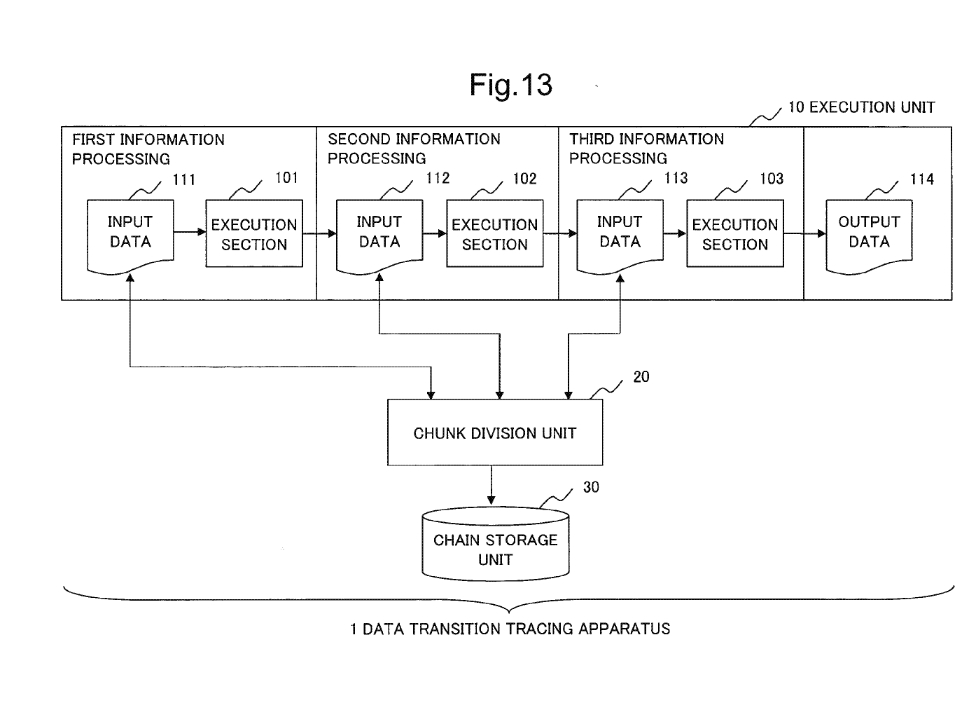

FIG. 13 is a block diagram showing a configuration of a data transition tracing apparatus of the third exemplary embodiment of the present invention. The data transition tracing apparatus of the present exemplary embodiment has the execution unit 10, the chunk division unit 20 and the chain storage unit 30.

The execution unit 10 is provided with the execution sections 101, 102 and 103 each of which performs a set of information processing which receives a plurality of chunks which are sets of data records and outputs output chunks associated with the input chunk, onto the respective input chunks.

With respect to each of the second and later execution sections, the chunk division unit 20 rearranges output chunks outputted by the execution section located at a preceding stage into the input chunk to be inputted to the execution section in question (“the execution section in question” means above-described “each of the second and later execution sections”.) located at a succeeding stage of the preceding stage.

The chunk division unit 20 stores, into the chain storage unit 30, chain information which shares any of the data records and associates the input chunk with the output chunk outputted by the execution section located at the preceding stage.

Similarly to the first and the second exemplary embodiments, the present exemplary embodiment has the effect of enabling efficient debugging work through efficiently narrowing down paths of an error occurrence when the error occurs in data processing. It is because the chunk division unit 20 divides into chunks each of pieces of input data to be inputted to the respective execution sections in the execution unit 10, generates chain information associating the chunks with each other, and stores the chain information into the chain storage unit 30.

In the present exemplary embodiment, there may be a case where, on the basis of the chain information, a unit corresponding to the tracing unit 40 and the tracing information storing unit 50 in the first and the second exemplary embodiments generates information such as tracing information necessary for debugging, and also a case where a debugging operator directly analyzes the chain information to perform debugging work.

### <Example of Hardware Configuration>

In the exemplary embodiments described above, each unit or section illustrated in FIGS. 1, 11 and 13 can be regarded as a functional (processing) unit (software module) of a software program. Here, segmentation of the units or sections in those drawings is made to illustrate a configuration for convenience of description, and various configurations can be assumed when implementing them. An example of hardware environment in this case will be described with reference to FIG. 14.

FIG. 14 is a diagram illustrating a configuration of an information processing apparatus 900 (computer), as an example, which can perform as the data transition tracing apparatus according to each of the exemplary embodiments of the present invention. That is, FIG. 14 shows a configuration of a computer (information processing apparatus) such as a server which can realize the data transition tracing apparatuses shown in FIGS. 1, 11 and 13, and represents hardware environment which can realize the functions in the exemplary embodiments described above.

The information processing apparatus 900 shown in FIG. 14 is a general computer comprising a CPU (Central Processing Unit) 901, a ROM (Read Only Memory) 902, a RAM (Random Access Memory) 903, a hard disk (storage device) 904, a communication interface 905 connected with external devices, a reader/writer 908 capable of reading and writing data stored in a recording medium 907 such as a CD-ROM (Compact Disc Read Only Memory) and an input/output interface 909, wherein these components are connected with each other via a bus (communication wire) 906.

Then, the present invention described above taking the exemplary embodiments as examples is achieved by providing the information processing apparatus 900 shown in FIG. 14 with a computer program capable of realizing the functions in the block configuration diagrams (FIGS. 1, 11 and 13) or in the flow charts (FIGS. 2A to 2B and FIGS. 3A to 3B), which were referred to in the descriptions of the exemplary embodiments, and by then reading out the computer program into the CPU 901 of the hardware and interpreting and executing the computer program there. The computer program provided to the apparatus may be stored in a readable/writable volatile storage memory (RAM 903) or a non-volatile storage device such as the hard disk 904.

In the above-described case, it is possible to adopt a currently general procedure, as a method of providing a computer program into the hardware, such as a method of installing a program into the apparatus through various types of recording medium 907 and a method of downloading a program via a communication line such as the internet. In such cases, the present invention can be regarded as being constituted by the code constituting the computer program or by the non-transitory computer readable recording medium 907 storing the code.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A data transition tracing apparatus comprising:
an execution unit that sequentially executes sets of information processing, each of which receives a plurality of chunks which are sets of data records and outputs output chunks associated with the input chunk, onto the respective input chunks; and
a chunk division unit that, with respect to each of the second and later sets of the information processing individually, rearranges the output chunk outputted by the set of the information processing located at a preceding stage into the input chunk to be inputted to the set of the information processing in question located at a succeeding stage of the preceding stage and stores, into a chain storage unit, chain information which shares any of the data records and associates the input chunk with the output chunk outputted by the set of the information processing located at the preceding stage.

2. The data transition tracing apparatus according to claim 1, wherein,
with respect to each of the output chunks individually, the chunk division unit stores, into the chain storage unit, an identifier, as the chain information, enable of identifying the input chunk which is to be inputted to the set of the information processing located at the succeeding stage and includes the data record included in the output chunk.

3. The data transition tracing apparatus according to claim 1, wherein,
with respect to each of the input chunks individually, the chunk division unit stores, into the chain storage unit, an identifier as the chain information, enable of identifying the output chunk which is outputted by the set of the information processing located at the preceding stage and includes the data record included in the input chunk.

4. The data transition tracing apparatus according to claim 1, further comprising:
a tracing unit which, when an error is detected in the output chunk outputted by any set of the information processing, identifies the input chunk inputted to the information processing located at the first stage, by repeating, with reference to the chain storage unit, a tracing operation of identifying the output chunk outputted by the set of the information processing located at preceding stage so as to identify the set of the information processing located at the first stage of the sets of the information processing.

5. The data transition tracing apparatus according to claim 4, further comprising a tracing information storing unit, that performs:
inputting data records included in the input chunk inputted to the set of the information processing located at the first stage, which have been identified by the tracing unit, one by one to the execution unit, thus causing the execution unit to sequentially executes the set of the information processing,
with respect to each of the set of the information processing, associating a value indicating the input data records, a value indicating the output data records which are results for the input data records by the set of the information processing in question, and association information associating the output data records outputted by the set of the information processing located at the preceding stage of the set of the information processing in question with the input data records each other, and
storing the associated values into the tracing storage unit.

6. The data transition tracing apparatus according to claim 4 further comprising:
a tracing control unit that, after the execution unit processes all of the data records once, gathers all of the data records included in the input chunk, which have been identified by the tracing unit, inputted to the set of the information processing located at the first stage, then instructs the chunk division unit to set the number of data records included in the inputted chunk to be inputted to each of the set of the information processing at a value smaller by a predetermined value than that used in the first processing, and subsequently instructs the execution unit to process the data records again.

7. The data transition tracing apparatus according to claim 5, wherein, with respect to each of the input data records inputted to the set of the information processing, by referring to comment information which includes the identification information enable to identifying the set of the information processing in source codes of a program for executing the set of the information processing receiving the input data, the tracing information storing unit collects the source codes of the program relevant to the set of the information processing, and it also collects status information representing a status of the program from log information recorded when the input data was processed, and stores the source codes and status information of the program into the tracing storage unit.

8. The data transition tracing apparatus according to claim 5 further comprising:
a display unit which, based on information stored in the tracing storage unit, with respect to each of the information processing, connects by a directional line an icon representing an input data record inputted to the information processing, setting it as a starting point, and an icon representing the input data record inputted to the set of the information processing located at the succeeding stage to the set of the information processing in question, which is also the output data record outputted by the set of the information processing in question which is relevant to the former input data record, and after that, when the difference between a coordinate representing the position of any one of the icons and that of a cursor becomes equal to or smaller than a predetermined value, displays detail information on the input data record relevant to the icon and, when the difference between a coordinate representing the position of the directional line and that of the cursor becomes equal to or smaller than a predetermined value, displays the source code of and the status information on the program relevant to the processing of the input data record relevant to the icon connected to the starting point of the directional line.

9. A data transition tracing method comprising:
by an information processing apparatus, sequentially executing sets of information processing, each of which receives a plurality of chunks which are sets of data records and outputting output chunks associated with the input chunk, onto the respective input chunks; and
by the information processing apparatus, with respect to each of the second and later sets of the information processing individually, rearranging the output chunk outputted by the set of the information processing located at a preceding stage into the input chunk to be inputted to the set of the information processing in question located at a succeeding stage of the preceding stage and storing, into a storage unit, chain information which shares any of the data records and associating the input chunk with the output chunk outputted by the set of the information processing located at the preceding stage.

10. A non-transitory computer-readable medium storing a computer program causing a computer to realize:
an execution function that sequentially executes sets of information processing, each of which receives a plurality of chunks which are sets of data records and outputs output chunks associated with the input chunk, onto the respective input chunks; and
a chunk division function that, with respect to each of the second and later sets of the information processing individually, rearranges the output chunk outputted by the set of the information processing located at a preceding stage into the input chunk to be inputted to the set of the information processing in question located at a succeeding stage of the preceding stage and stores, into a storage unit, chain information which shares any of the data records and associates the input chunk with the output chunk outputted by the set of the information processing located at the preceding stage.

11. A data transition tracing apparatus comprising:
execution means for sequentially executing sets of information processing, each of which receives a plurality of chunks which are sets of data records and outputs output chunks associated with the input chunk, onto the respective input chunks; and
chunk division means for, with respect to each of the second and later sets of the information processing individually, rearranging the output chunk outputted by the set of the information processing located at a preceding stage into the input chunk to be inputted to the set of the information processing in question located at a succeeding stage of the preceding stage and stores, into a storage unit, chain information which shares any of the data records and associates the input chunk with the output chunk outputted by the set of the information processing located at the preceding stage.
